(19) United States
(12) Patent Application Publication
(10) Pub. No.: US 2012/0090463 A1
(43) Pub. Date: Apr. 19, 2012

(54) PROCESS AND APPARATUS FOR THE TREATMENT OF FLUE GASES

(75) Inventors: Torsten Stoffregen, Dresden (DE); Veselin Stamatov, Dresden (DE); Thomas Walter, Munchen (DE)

(73) Assignee: Linde-Kca-Dresden GmbH, Dresden (DE)

(21) Appl. No.: 13/263,538

(22) PCT Filed: Apr. 8, 2010
(86) PCT No.: PCT/EP2010/002200

§ 371 Date: Dec. 19, 2011

(30) Foreign Application Priority Data
Apr. 9, 2009 (EP) 10 2009 017 228.9

(51) Int. Cl. B01D 53/14; B01D 53/00

(52) U.S. Cl. 95/42; 95/39; 55/315.1; 96/243; 96/355

(57) ABSTRACT

A process and an apparatus for the treatment of a carbon dioxide-containing flue gas stream are described, at least part of the carbon dioxide present being removed from the flue gas stream in a separating device having in particular an absorption column 7 with the formation of a gas stream having a low carbon dioxide content and a carbon dioxide-rich gas stream. For overcoming the pressure drop caused by the carbon dioxide removal in the absorption column 7, it is proposed that the gas stream having a low carbon dioxide content and formed after the removal of the carbon dioxide from the flue gas stream is subjected to a gas stream compression, for example by means of a flue gas blower 14.

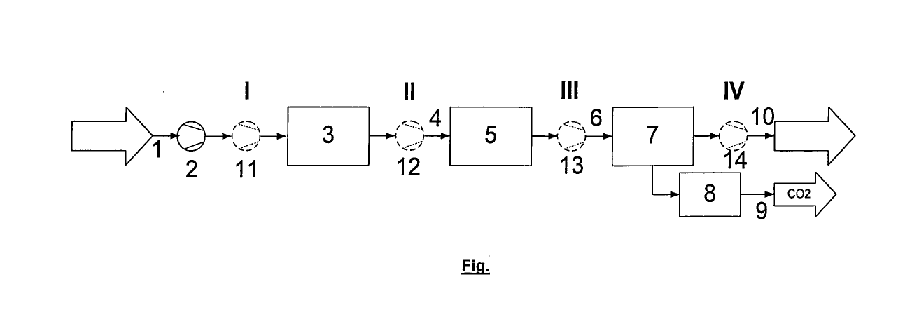

The invention relates to a process for the treatment of a carbon dioxide-containing flue gas stream, at least part of the carbon dioxide present being removed from the flue gas stream with the formation of a gas stream having a low carbon dioxide content and a carbon dioxide-rich gas stream, and to an apparatus for carrying out the process.

Power stations, i.e. industrial plants for the preparation of, in particular, electrical and in some cases additional thermal power, are indispensable for ensuring the energy supply of an economy. Such power stations use primary energy which, after appropriate conversion, is made available as useful energy. This results as a rule in carbon dioxide-containing gas streams which are usually released into the environment. Particularly in caloric power stations in which fossil fuels, i.e. coal, mineral oil or natural gas, are burned, waste gas streams designated as flue gases result, which have high carbon dioxide contents.

Very recently, new power station concepts have been proposed in which the carbon dioxide (CO₂) present in the flue gas is washed out of the flue gas in a scrubbing stage downstream of the power station and, for example, in the form of an absorption column. The power station need not, as in the case of so-called “oxyfuel power stations” be changed over to oxygen combustion, but can be operated conventionally with combustion of air. The aim of these new concepts is to force the carbon dioxide forming during the combustion of the fossil fuels and present in the flue gas into suitable deposits, in particular into certain rock strata or saltwater-carrying strata and thus to limit the carbon dioxide output to the atmosphere. It is intended thereby to reduce the climatically harmful effect of greenhouse gases, such as carbon dioxide. This technology is referred to by those skilled in the art as so-called “Post Combustion Carbon Capture Technology (PCC)”.

Carbon dioxide-containing flue gas streams are also obtained in other large furnaces which are operated with fossil fuels. These include, for example, industrial furnaces, steam boilers and similar large thermal plants for electricity and/or heat generation. It is conceivable that in such plants too the carbon dioxide is separated from the flue gas streams by means of scrubbing and is fed for utilization or storage (for example by forcing underground).

In the separation of carbon dioxide from flue gases by washing out by means of chemical and/or physical scrubbing agents, the pressure drop which is caused by the separation must be overcome by a gas stream compression device, e.g. a flue gas blower. The PCC processes are distinguished in that cooling by means of scrubbing with water is also carried out before the absorption column in order to be able to enter the absorption column at a lower temperature. A flue gas blower which overcomes the pressure drop via dust separation and flue gas desulphurization is already installed as standard in the flue gas stream after the power station boiler in conventional processes for flue gas treatment. For the additional pressure drop due to the scrubbing provided for the CO₂ separation, an additional blower must be installed.

It is therefore an object of the present invention to configure a process of the type mentioned at the outset and an apparatus for carrying out the process in such a way that the pressure drop caused by the removal of carbon dioxide can be overcome in an economical manner.

According to the invention, this object is achieved in terms of the process if the gas stream having a low carbon dioxide content and formed after the removal of the carbon dioxide from the flue gas stream is subjected to a gas stream compression.

The invention is based on the consideration that in principle four circuit variants are possible for the additional gas stream compression (see figure). These variants differ with respect to the operating and capital costs, the optimum in terms of operating and capital costs being realized by the circuit according to the invention (circuit IV).

An obvious circuit variant consists in designing the flue gas blower present to date with a higher power (higher ΔP) (circuit I). However, this has the disadvantage that the following installations have to be designed for a higher pressure (disadvantage with respect to capital costs) and the flue gas stream also has the highest temperature and flow rate at this point (high proportion of water and CO₂), which leads to a high demand for electrical energy (high operating costs). The arrangement of the flue gas blower before the flue gas cooling (circuit II) leads to higher operating costs due to the higher temperature and the higher water content. The arrangement of the flue gas blower after the flue gas cooling (circuit III) has the disadvantage that the flue gas cooling cannot be integrated into the absorption column and likewise has higher operating costs.

Overall, the conceivable circuit variants II and III already have improved energy and operating costs but do not constitute the optimum since the flue gas still contains the full amount of CO₂.

The circuit IV proposed according to the invention and comprising the arrangement of the gas stream compression after the removal of the carbon dioxide constitutes the optimum variant with respect to operating and capital costs. Reasons for this are:

The CO₂ separation before the gas stream compression gives a minimum flue gas volume flow, with the result that, with the use of a flue gas blower for gas stream compression, a blower power which is lower, in some cases considerably lower, is required. Owing to the heating of the flue gas by the gas stream compression in a flue gas blower downstream of the CO₂ separation, an increased flue gas exit temperature (e.g. 51° C.) is obtained, with the result that altogether a smaller cooling power is required (temperature increase due to the flue gas blower need not be eliminated again by cooling). An additional advantage of the increased flue gas temperature of the low-CO₂ stream is an improved updraft of the flue gas in the cooling tower and hence an improved cooling tower performance. Finally, on using absorption columns for the CO₂ separation, this circuit permits a reduction of the absorption column entry temperature by means of cooling water to below 40° C. at central European latitudes (depending on the forward flow temperature of the cooling water). As a result, the CO₂ absorption is improved and energy can be saved.

The present invention is primarily intended for the treatment of flue gases from conventional combustion plants. The carbon dioxide-containing flue gas stream is formed in a large furnace in which fossil fuels are burned with combustion air. This flue gas stream is preferably subjected to scrubbing in an absorption column with subsequent scrubbing agent regeneration for the separation of carbon dioxide from the flue gas stream. By expelling gaseous components during the scrubbing agent regeneration, the carbon dioxide-rich gas stream is expediently formed while the gas stream having a low carbon dioxide content is taken off from the absorption column.

Preferably, the carbon dioxide is removed from the carbon dioxide-containing flue gas stream by means of scrubbing with a physically and/or chemically acting scrubbing agent. The scrubbing agent expediently contains at least one amine as a constituent.

The scrubbing is carried out at a slightly reduced pressure between −100 mbar and −10 mbar, preferably in the range from −40 to −80 mbar.

The carbon dioxide removed from the flue gas stream can finally be fed for use or storage, in particular for being forced underground, while the gas stream having a low carbon dioxide content can be released to the atmosphere with a considerably reduced climatically harmful effect.

The invention furthermore relates to an apparatus for the treatment of a carbon dioxide-containing flue gas stream, comprising a separating device for separating the flue gas stream into a carbon dioxide-rich gas stream and a gas stream having a low carbon dioxide content, the separating device having a discharge line for the carbon dioxide-rich gas stream and a discharge line for the gas stream having a low carbon dioxide content.

In terms of the apparatus, the object set is achieved in that the discharge line for the gas stream having a low carbon dioxide content is connected to a gas stream compression device which is downstream of the separating device.

Preferably, the separating device has at least one absorption column. This is advantageously configured in such a way that flue gas cooling and carbon dioxide scrubbing are integrated. Another variant envisages that the gas stream compression device is connected downstream of a column system comprising separate columns for the flue gas cooling and carbon dioxide scrubbing.

The absorption column expediently has a diameter of at least 3 m, in particular 10 to 25 m, or an equivalent rectangular cross section. The invention has a whole range of advantages:

Arranging the CO₂ separation before the gas stream compression results in a considerable decrease in the flue gas volume flow. Consequently, a substantially lower blower power is required for the flue gas blower. Owing to the heating of the flue gas by the gas stream compression, an increased flue gas exit temperature (e.g. 51° C.) is obtained, with the result that altogether a lower cooling power is required. (Temperature increase due to the flue gas blower need not be eliminated again by cooling). An additional advantage of the increased flue gas temperature of the low-CO₂ stream is an improved updraft of the flue gas in the cooling tower and hence an improved cooling tower performance. Finally, the invention permits a reduction in the absorption column entry temperature by means of cooling water below 40° C. at central European latitudes (depending on the forward flow temperature of the cooling water). As a result, the CO₂ absorption improves substantially. Moreover, energy can be saved thereby.

The invention is suitable for all conceivable large furnaces in which carbon dioxide-containing gas streams occur. These include, for example, power stations operated with fossil fuels, industrial furnaces, steam boilers and similar large thermal plants for electricity and/or heat generation. The invention can particularly advantageously be used in large furnaces which are supplied with air as combustion gas. The invention is particularly suitable for coal-fired power stations in which the CO₂ is washed out of the flue gas and forced underground (“CCS—Carbon Capture and Storage”).

Below, the invention is to be explained in more detail with reference to a working example shown schematically in the figure:

The figure shows a block diagram of a flue gas purification with different circuit variants for the arrangement of the gas stream compression.

The flue gas stream of a combustion vessel (not shown) of a large furnace, in particular of a coal-fired power station, is fed by a line 1 to a flue gas blower 2 and then to a flue gas desulphurization plant 3. The pressure drop caused by the flue gas desulphurization plant 3 is overcome by means of the flue gas blower 2. The desulphurized flue gas is then subjected, via line 4, to precooling by means of scrubbing with water in a direct contact cooler 5. Thereafter, the cooled flue gas is fed via line 6 to an absorption column 7 in which a major part of the carbon dioxide is washed out of the flue gas with a scrubbing agent containing an amine. The carbon dioxide washed out is fed to a stripper 8. Finally, a carbon dioxide-rich gas stream is taken off from the stripper 8 via line 9 and can be forced underground for storage. The gas stream having a low carbon dioxide content and having a greatly reduced climatically harmful effect is taken off from the absorption column 7 via line 10 and can be released to the atmosphere. In order to be able to overcome the additional pressure drop caused by the absorption column 7, an additional flue gas blower must be installed. In principle, four different circuit variants are conceivable for this purpose. In the case of circuit I, an additional flue gas blower 11 is arranged immediately behind the already present flue gas blower 2 or the existing flue gas blower 2 is designed with a higher power. Circuit II envisages that the additional flue gas blower 12 is arranged between the flue gas desulphurization plant 3 and the direct contact cooler 5. In the case of circuit III, the additional flue gas blower 13 is connected between the direct contact cooler 5 and the CO₂ absorber 7. However, the circuits I to III have the substantial disadvantage that the flue gas still contains the full amount of carbon dioxide. The invention therefore envisages, according to circuit IV, that the additional flue gas blower 14 following the absorption column 7 is connected into the flue gas stream having a low carbon dioxide content in line 10. Since a major part of the carbon dioxide is already removed from the flue gas before the flue gas blower 14 in the case of this arrangement, the flue gas blower 14 can be supplied with a minimum flue gas volume flow, with the result that the blower power can be reduced. Moreover, the fact that the flue gas is heated only after the absorption column 7 via the flue gas blower 14 has a positive effect on the CO₂ absorption. In particular, the energy demand decreases considerably, as shown by the following comparison of the various circuit variants:

| 1100 | | | | |
|---|---|---|---|---|
| MWₑₗ | Circuit 1 | Circuit 2 | Circuit 3 | Circuit 4 |
| Electric | 0 | −20% | −27% | −32% |
| power⁽¹⁾ | | | | |

⁽¹⁾The electric power includes not only the flue gas blower power but also the pump power of the precooling, which likewise varies with the position of the flue gas blower.

The cooling power which must be applied for cooling the flue gas decreases by about 8% in the case of the circuit 4 according to the invention compared to the circuits 1-3, since the heat which the flue gas blower inputs into the flue gas stream does not require additional cooling.

If the flue gas blower is arranged after the absorption column 7, it is also possible to integrate the precooling 5 into the absorber column 7. This has further advantages with regard to piping outlay, pressure drop, space requirement and capital costs.

1. Process for the treatment of a carbon dioxide-containing flue gas stream, at least part of the carbon dioxide present being removed from the flue gas stream with the formation of a gas stream having a low carbon dioxide content and a carbon dioxide-rich gas stream, characterized in that the gas stream having a low carbon dioxide content and formed after the removal of the carbon dioxide from the flue gas stream is subjected to a gas stream compression.

2. Process according to claim 1, characterized in that the carbon dioxide-containing flue gas stream is formed in a large furnace in which fossil fuels are burned with combustion air.

3. Process according to claim 1, characterized in that the carbon dioxide is removed from the carbon dioxide-containing flue gas stream by means of scrubbing with a physically and/or chemically acting scrubbing agent.

4. Process according to claim 3, characterized in that the scrubbing agent contains at least one amine as a constituent.

5. Process according to claim 3, characterized in that the scrubbing is carried out at a slightly reduced pressure between −100 mbar and −10 mbar, preferably in the range from −40 to −80 mbar.

6. Process according to claim 1, characterized in that the carbon dioxide removed from the flue gas stream is fed for use or storage.

7. Apparatus for the treatment of a carbon dioxide-containing flue gas stream, comprising a separating device for separating the flue gas stream into a carbon dioxide-rich gas stream and a gas stream having a low carbon dioxide content, the separating device having a discharge line for the carbon dioxide-rich gas stream and a discharge line for the gas stream having a low carbon dioxide content, characterized in that the discharge line for the gas stream having a low carbon dioxide content is connected to a gas stream compression device which is downstream of the separating device.

8. Apparatus according to claim 7, characterized in that the separating device has at least one absorption column.

9. Apparatus according to claim 7, characterized in that the gas stream compression device is connected downstream of an absorption column in which the flue gas cooling and carbon dioxide scrubbing are integrated.

10. Apparatus according to claim 7, characterized in that the gas stream compression device is connected downstream of a column system comprising separate columns for the flue gas cooling and carbon dioxide scrubbing.

11. Apparatus according to claim 7, characterized in that the absorption column has a diameter of at least 3 m, in particular 10 to 25 m, or an equivalent rectangular cross section.
